(19) United States
(12) Patent Application Publication
(10) Pub. No.: US 2006/0156975 A1
(43) Pub. Date: Jul. 20, 2006

(54) Integrated apparatus of substrate treatment for manufacturing of color filters by inkjet printing systems

(76) Inventors: Fan Cheung Sze, San Jose, CA (US); Quanyuan Shang, Saratoga, CA (US); John M. White, Hayward, CA (US)

Correspondence Address: PATTERSON & SHERIDAN, LLP, 3040 POST OAK BOULEVARD, SUITE 1500, HOUSTON, TX, 77056, US

(21) Appl. No.: 11/180,364

(22) Filed: Jul. 13, 2005

Related U.S. Application Data
(63) Continuation-in-part of application No. 11/039,603, filed on Jan. 18, 2005.

(51) Int. Cl. B05D 5/12; B05C 5/00; B05B 7/06

(52) U.S. Cl. 118/300; 427/66; 427/258; 118/313

(57) ABSTRACT

Embodiments of the invention describe an apparatus and a method for treating a substrate of flat panel display is provided. In one embodiment, an inkjet printing system for a substrate of flat panel display comprises a chemical compound application assembly that applies chemical compound(s) on the substrate of flat panel display, a stage that supports the substrate of flat panel display and a stage positioning system that moves the stage, and an inkjet printing module that dispenses inkjet on the substrate of flat panel display. In another embodiment, a processing system for a substrate of flat panel display comprises a chemical compound application assembly that applies chemical compound(s) on the substrate of flat panel display wherein the chemical compound application assembly has a chemical compound applicator whose width substantially spans the width of the substrate of flat panel display, and a stage that supports the substrate of flat panel display and a stage positioning system that moves the stage. In another embodiment, a method of processing a substrate of flat panel display comprises depositing a layer comprising a chemical compound on the surface of a substrate of flat panel display by a chemical compound application assembly, whose width spans substantially the width of the substrate of flat panel display, of a processing system, and then inkjetting at least three colors on the substrate of flat panel display by an inkjet printing module of the processing system.

### CROSS-REFERENCE TO RELATED APPLICATIONS

This application is a continuation-in-part of co-pending U.S. patent application Ser. No. 11/039,603, filed on Jan. 18, 2005, which is herein incorporated by reference.

### BACKGROUND OF THE INVENTION

1. Field of the Invention

Embodiments of the invention generally relate to flat panel displays and particularly relate to an apparatus for treating a substrate having a black matrix for use in manufacturing flat panel displays.

2. Description of the Related Art

Flat panel displays (FPDs) have become the favored display technology for computers, televisions, and personal electronic devices such as cell phones, personal digital assistants, etc. Liquid crystal displays (LCDs) are a preferred type of commercially available FPDs. Different colors are obtained in liquid crystal displays by transmitting light through a color filter located on a substrate of a LCD. The color filter includes pixels, wherein each pixel may include three colors, typically red, green, and blue. Each color of a pixel may be considered a sub-pixel. Typically, each sub-pixel is surrounded by a black matrix material that provides an opaque area between sub-pixels and therefore prevents light leakage in the thin film transistors (TFTs) of the LCDs. FIG. 1 (prior art) is a top view of two adjacent pixels 1 and 2. Pixel 1 includes three sub-pixels 3, 4, and 5, and pixel 2 includes three sub-pixels 6, 7, and 8. Black matrix material 9 surrounds and separates each of the sub-pixels 3, 4, 5, 6, 7, and 8.

Traditional methods of producing color filters, such as dyeing, lithography, and electrodeposition, require the sequential introduction of the three colors. That is, a first set of pixels having one color is produced by a series of steps, whereupon the process must be repeated twice more to apply all three colors. The series of steps involved in this process includes at least one curing phase in which the deposited liquid color agent must be transformed into a solid, permanent form. Thus, such traditional methods of producing color filters can be very time consuming. Also, as each color agent is processed by a separate line of equipment, equipment costs for such traditional methods are high.

Methods of using inkjet systems that allow the deposition of all three colors simultaneously have been developed. An inkjet system may be used to deposit different colors through different nozzles into wells created by a patterned black matrix on a substrate, wherein each well corresponds to a sub-pixel. However, the formation of color filters remains challenging. For example, as the size of pixels and sub-pixels decreases, the precision of the delivery of the ink into the sub-pixel wells created by the patterned black matrix must be increased. Furthermore, the surface properties of the glass and the black matrix are becoming increasingly important, as it is desired that the ink be able to spread and uniformly fill a small well within the black matrix and yet not spread across and over the black matrix into a neighboring well. A non-uniformly filled sub-pixel well, i.e., a well having an irregular ink upper surface profile, is undesirable, as it will typically not provide a uniform color.

Convex ink upper surface profiles and concave ink upper surface profiles are two examples of irregular ink upper surface profiles that may result, at least in part, from an ink contacting a black matrix having undesirable surface properties. A convex ink upper surface profile may be caused by a black matrix having surface properties that repel the ink away from the black matrix and towards the center of the sub-pixel well. An example of a cross-section of a sub-pixel well surrounded by a black matrix having surface properties that result in a convex ink upper surface profile is shown in FIG. 2 (prior art). A sub-pixel well 10 is surrounded by a black matrix 12. The black matrix 12 has surface properties such that ink 14 deposited in the sub-pixel well 10 is repelled by the sidewalls 18 of the sub-pixel well 10, resulting in a convex, dome-shaped upper surface profile 16 of the ink 14 within the sub-pixel well 10 rather than a uniform upper surface profile.

A concave ink upper surface profile may be caused by a black matrix having surface properties that attract the ink away from the center of the sub-pixel well and towards the black matrix. An example of a cross-section of a sub-pixel well surrounded by a black matrix having surface properties that result in a concave ink upper surface profile is shown in FIG. 3 (prior art). The ink 14 in the sub-pixel well 10 of FIG. 3 has a concave upper surface profile 20, as the sidewalls 18 comprising the black matrix 12 of the sub-pixel well 10 attract the ink such that the ink is raised by the attraction force along the sidewalls and away from the center of the sub-pixel well.

The outer surface of the glass substrate that is not covered by the black matrix, i.e., the surface of the glass substrate that contacts the ink in the sub-pixel wells, may also have undesirable surface properties. For example, a glass substrate outer surface that has a high affinity for an ink may result in the spreading of the ink deposited in one sub-pixel well to another sub-pixel well. FIG. 4 (prior art) shows an example of a drop of ink 30 that was deposited in sub-pixel well 32 and then spread over the black matrix 34 into adjacent sub-pixel well 36.

Therefore, a need exists for an improved apparatus and method forming color filters for flat panel displays. In particular, there is a need for an apparatus and a method of providing a patterned black matrix that enhances the formation of color filters having sub-pixel wells that have a uniform distribution of ink within each well.

### SUMMARY OF THE INVENTION

The present invention provides an apparatus and a method of treating a substrate for a flat panel display. In one embodiment, an inkjet printing system for a substrate of flat panel display comprises a chemical compound application assembly that applies chemical compound(s) on the substrate of flat panel display, a stage that supports the substrate of flat panel display and a stage positioning system that moves the stage, and an inkjet printing module that dispenses inkjet on the substrate of flat panel display.

In another embodiment, a processing system for a substrate of flat panel display comprises a chemical compound application assembly that applies chemical compound(s) on the substrate of flat panel display wherein the chemical compound application assembly has a chemical compound applicator whose width substantially spans the width of the substrate of flat panel display, and a stage that supports the substrate of flat panel display and a stage positioning system that moves the stage.

In another embodiment, a processing system for a substrate of flat panel display comprises a chemical compound application assembly that applies chemical compound(s) on the substrate of flat panel through a chemical compound applicator of the chemical compound application assembly.

In yet another embodiment, a method of processing a substrate of flat panel display comprises depositing a layer comprising a chemical compound on the surface of a substrate of flat panel display by a chemical compound application assembly, whose width spans substantially the width of the substrate of flat panel display, of a processing system, and then inkjetting at least three colors on the substrate of flat panel display by an inkjet printing module of the processing system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 (Prior Art) is a top view of two pixels each containing three sub-pixels according to the prior art.

FIG. 2 (Prior Art) is a cross-section of a sub-pixel well surrounded by a black matrix material according to the prior art.

FIG. 3 (Prior Art) is a cross-section of a sub-pixel well surrounded by a black matrix material according to the prior art.

FIG. 4 (Prior Art) is a top view of two sub-pixels according to the prior art.

FIG. 5 is a cross-section of a sub-pixel well surrounded by a black matrix material according to embodiments of the invention.

FIG. 6A is a schematic view of an inkjet printing apparatus comprising a chemical compound application assembly according to an embodiment of the invention.

FIG. 6B is a schematic view of an inkjet printing apparatus comprising a chemical compound application assembly according to another embodiment of the invention.

FIG. 7A is a schematic cross-sectional view of the chemical compound application assembly shown in FIG. 6.

FIGS. (A) and (B) of 7B are schematic top views of a baffle plate in the vapor applicator.

FIG. 7C is a schematic top view of a heated divider in the vapor applicator.

FIG. 7D is a schematic side view of an embodiment of a chemical compound applicator.

FIG. 7E is a schematic top view of an embodiment of a chemical compound applicator of FIG. 7D.

FIG. 7F is a schematic side view of an embodiment of a chemical compound applicator.

FIG. 8 shows a schematic side view of an inkjet printing apparatus comprising the chemical compound application assembly shown in FIG. 6.

FIG. 9 shows a schematic side view of an embodiment of an inkjet printing apparatus comprising a chemical compound application assembly.

### DETAILED DESCRIPTION

Embodiments of the invention provide an apparatus and a method of treating a substrate, which could be made of glass or other types of materials, and a black matrix thereon that enhances the formation of color filters having sub-pixel wells that have a substantially uniform distribution of ink therein. The substrate and black matrix are treated under conditions sufficient to modify the surface energy of at least one member selected from the group consisting of the black matrix and an outer surface of the substrate that is not covered by the black matrix, such that ink deposited in the sub-pixel wells has a substantially uniform upper surface profile. As defined herein, a sub-pixel well having an ink thickness variation across the sub-pixel well of up to about +/−15% is a sub-pixel well having a substantially uniform upper surface profile. The ideal ink surface thickness uniformity is +/−3%. A sub-pixel well having an ink thickness variation across the sub-pixel well of up to about +/−15% and a surface profile that is substantially uniform in the middle of a sub-pixel well and slightly concave at the edges of the sub-pixel well is an example of a sub-pixel well having a substantially uniform upper surface profile. The resulting black matrix and substrate surface energy are such that the ink spread is sufficiently flat inside the sub-pixel wells and little ink is spread on the black matrix surface and into adjacent wells. A slightly convex or concave ink upper surface profile will not affect the color quality of the display. A slightly concave ink upper surface profile is preferred.

An example of a cross-section of a sub-pixel well surrounded by a black matrix treated according to embodiments herein is shown in FIG. 5. The ink 14 in the sub-pixel well 10 of FIG. 5 has a substantially uniform upper surface profile 22 as it is not strongly repelled or attracted by the sidewalls 18 of the sub-pixel well 10.

As defined herein, a material such as a glass substrate or a black matrix that has an outer surface such that an ink deposited thereon tends to spread is ink-philic, and a material such as a glass substrate or a black matrix that has an outer surface such that an ink deposited thereon does not tend to spread is ink-phobic. Furthermore, as used herein, increasing the attractive force between a material, such as a glass substrate or a black matrix, and an ink deposited thereon such that the tendency of the ink to spread on the material is increased is referred to as either increasing the ink-philicity of the material or decreasing the ink-phobicity of the material. Decreasing the attractive force between a material, such as a glass substrate or a black matrix, and an ink deposited thereon such that the tendency of the ink to spread on the material is decreased is referred to as either increasing the ink-phobicity of the material or decreasing the ink-philicity of the material.

In one embodiment, modifying the surface energy of an outer surface of the glass substrate that is not covered by the black matrix comprises increasing the ink-phobicity of the outer surface of a glass substrate that when untreated has a high affinity for an ink to be deposited in the sub-pixel wells defined by the black matrix, and thus typically results in ink spreading over the black matrix, as shown in FIG. 4. Increasing the ink-phobicity of the outer surface of such a glass substrate reduces the tendency of the deposited ink to flow towards the sidewalls and over the black matrix.

In another embodiment, modifying the surface energy of the black matrix comprises increasing the ink-phobicity of the outer surface of a black matrix that when untreated has a high affinity for an ink to be deposited in the sub-pixel wells defined by the black matrix and thus typically results in a concave ink upper surface profile as shown in FIG. 3. As defined herein, the outer surface of a black matrix consists of the surfaces of the black matrix that do not contact the glass substrate. Increasing the ink-phobicity of the outer surface of such a black matrix reduces the tendency of the deposited ink to flow preferentially to the sidewalls and away from the center of the sub-pixel well.

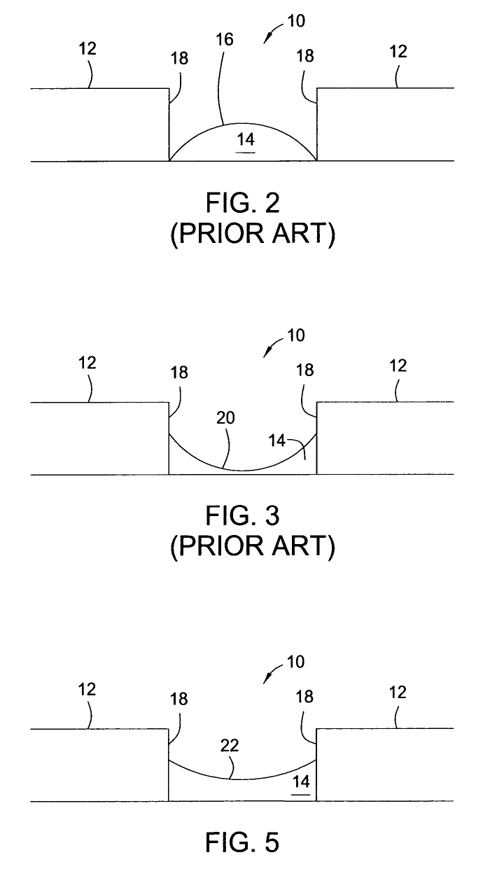

In a further embodiment, modifying the surface energy of an outer surface of the glass substrate that is not covered by the black matrix comprises decreasing the ink-phobicity of the outer surface of a glass substrate that when untreated has a low affinity for an ink to be deposited in the sub-pixel wells defined by the black matrix and thus typically results in a convex ink upper surface profile as shown in FIG. 2. Decreasing the ink-phobicity of the outer surface of such a glass substrate reduces the tendency of the deposited ink to form a dome-shaped bead of ink within the center of the sub-pixel well.

In another embodiment, modifying the surface energy of the black matrix comprises decreasing the ink-phobicity of the outer surface of a black matrix material that when untreated has a low affinity for an ink to be deposited in the sub-pixel wells defined by the black matrix and thus typically results in a convex ink upper surface profile as shown in FIG. 2. Reducing the ink-phobicity of the outer surface of such a black matrix material reduces the tendency of the deposited ink to flow preferentially away from the sidewalls of the sub-pixel well.

In any of the embodiments of the invention, the glass substrate and the black matrix are exposed to a surface active compound to modify the surface energy of the glass substrate, the surface energy of the black matrix, or the surface energies of both. In one aspect, the surface active compound may be any compound or mixture of compounds that adheres both to a glass substrate and a black matrix and that does not substantially react with or change the properties of an ink deposited thereon. For example, the surface active compound may form a layer when deposited on the glass substrate and black matrix such that the layer comprises a first side adapted to provide an ink-phobic surface or an ink-philic surface and a second side opposite the first side and adapted to adhere to the glass substrate and black matrix. The layer has a thickness sufficient to modify the surface energy of the glass substrate, black matrix, or both while not depositing a substantial amount of material in the sub-pixel well. For example, the layer may have a thickness of about a submonolayer, e.g., about 5 Å, to about 100 Å. The layer may consist of one or several monolayers of the surface active compound. In one embodiment, the surface active compound includes a silicon component that adheres to the glass and a hydrocarbon component that provides an ink-phobic surface. An example of such a surface active compound is a silane-based organic compound, such as a silicone oil. Other surface active compounds that may be used include fluorinated hydrocarbons, such as fluoroalkyl polyoxyethylene polymers, long chain hydrocarbon-based acids, such as oleic acid, long chain hydrocarbon-based esters, such as esters having the general structure of R₁COOR₂, where R₁ and R₂ are hydrocarbon compounds, long chain hydrocarbon-based phosphates, long chain hydrocarbon-based sulfates, and combinations thereof.

It is recognized that the selection of the surface active compound should be made in view of the surface properties of the ink to be deposited in the sub-pixel well and of the black matrix surrounding the sub-pixel wells. For example, in order to increase the ink-phobicity of the outer surface of a black matrix relative to a selected ink, a surface active compound having a lower surface energy than the selected ink should be used. In order to reduce the ink-phobicity of the outer surface of a black matrix material relative to a selected ink, a surface active compound having a higher surface energy than the selected ink should be used. The surface energy of the ink may be between about 25 dynes/cm and about 35 dynes/cm. The ink surface energies described herein were measured using an EZ-Pi tensiometer, available from Kibron Inc. of Finland, according to the manufacturer's instructions. The tensiometer was initialized and calibrated with deionized water before the measurements were taken. The surface energies may also be measured using other apparatus, such as other commercially available tensiometers. The surface energies of two of the surface active compounds described herein, S-107B, a fluoroalkyl polyoxyethylene polymer from Chemguard, and a silicone oil are 21 dynes/cm and 21.5 dynes/cm respectively. As defined herein, the treatment-modified surface energy of the surface active compound-treated surface of the glass substrate and the black matrix is the surface energy of the surface active compound, which may be measured by an EZ-Pi tensiometer or other commercially available tensiometers. Preferably, the surface energy difference between the selected ink and the surface active compound-treated surface of the glass substrate and the black matrix is between about 4 dynes/cm and about 12 dynes/cm, such as between about 4 dynes/cm and about 10 dynes/cm, and is more preferably about 10+/−2 dynes/cm when the surface energies of the ink and the surface active compound are measured by an EZ-Pi tensiometer.

The surface active compound may be delivered to the glass substrate and black matrix in multiple ways. In one embodiment, the surface active compound is a solid or a liquid that is vaporized before the glass substrate and black matrix are exposed to the surface active compound. The black matrix and glass substrate may be exposed to the vaporized surface active compound by passing the substrate through a vapor phase of the surface active compound and a carrier gas, such as an inert gas or nitrogen, or a carrier gas mixture, such as air. A thin layer or coating of the surface active compound is deposited from the vaporized surface active compound onto the black matrix and glass substrate.

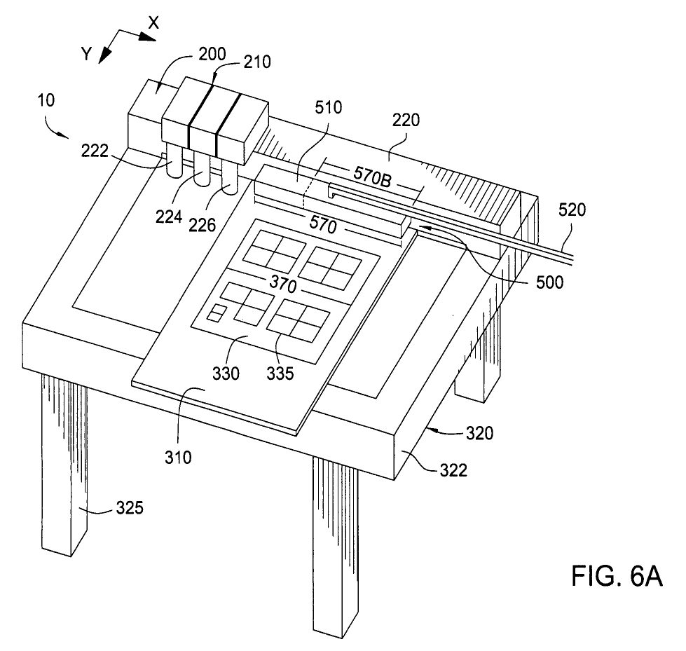

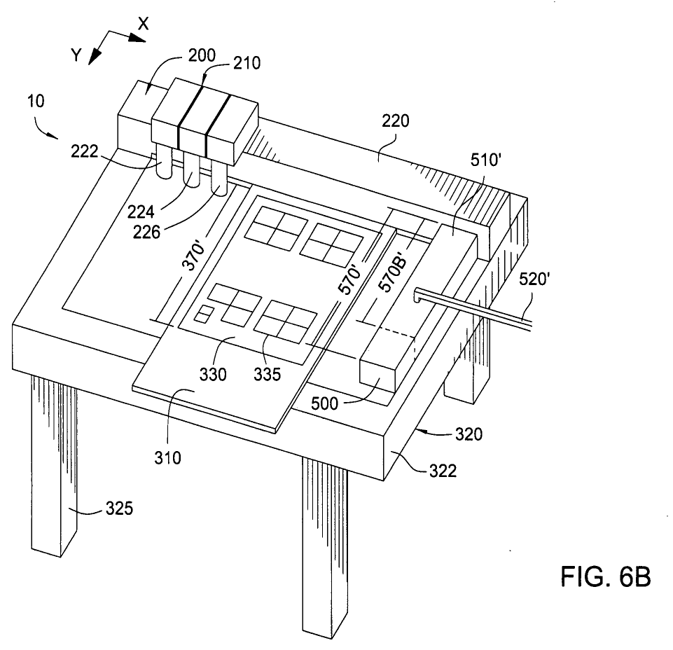

FIG. 6 is a perspective view of an exemplary embodiment of an inkjetting apparatus 10 to form color filters in flat panel displays of the present invention. FIG. 6 illustrates components of a stage positioning system 320 which includes a stage 310. In the embodiment shown in FIG. 6, the stage 310 moves in the Y direction and the inkjet heads 222, 224, and 226 of an inkjet printing module 210 move in the X direction. In other embodiments, the stage 310 could move in both X and Y directions. A stage moving device (not shown) with one or more motors could be used to move the stage 310 in the Y-axis direction. In an exemplary embodiment, the substrate stage 310 can also be rotatable by using an appropriate stage rotating device (not shown). The stage 310 can also be rotated so as to rotate and/or orient the substrate 330 for aligning the substrate 330 and the display object(s) contained thereon with an inkjet printing module 210 of a inkjet printing system 200.

The stage 310 can be of any appropriate or suitable size to support a substrate or substrates which are to be processed. In an exemplary embodiment, the apparatus 10 and its component parts can, for example, process substrates having dimensions of, for example, 5000 cm² and above. The apparatus 10 and its component parts can be designed and adapted to process substrates having any size.

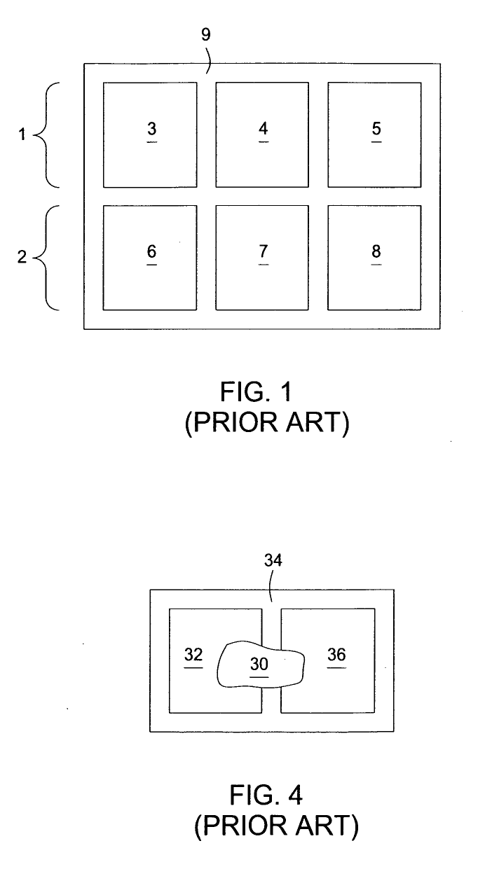

With reference once again to FIG. 6, the processing apparatus 10 also include a stage positioning system 320 which supports the substrate stage 310 and which, in an exemplary embodiment, can include a top portion 322 and a plurality of legs 325. Each leg may include an air cylinder or other cushioning mechanism (not shown) to isolate the stage 310 from vibrations (e.g., from the floor on which the processing apparatus 10 rests). The stage positioning system 320 can also include a controller (not shown) for controlling the operation of the stage moving device (not shown). The substrate 330 shown in FIG. 1 can include any number of display objects 335.

FIG. 6A illustrates an inkjet printing module 210 of the inkjet printing system 200 and an inkjet printing module support 220 on which the inkjet printing module 210 is mounted. In an exemplary embodiment, the inkjet printing module 210 is moveable along the inkjet printing module support 220 by an inkjet positioning device (not shown). In the embodiment of FIG. 6A, the inkjet printing module 210 includes three, or more, inkjet devices 222, 224 and 226. In an exemplary embodiment, each inkjet device 222, 224 and 226 can dispense a different color ink, for example red, green, blue, and optionally a clear ink, depending upon the color system being utilized. For example, a first inkjet device can dispense Red ink, a second inkjet device can dispense Green ink and a third inkjet device can dispense Blue ink. In another exemplary embodiment, any one or more of the inkjet devices can dispense a same color ink or a clear ink. Although described as being equipped with three inkjets devices, the inkjet printing module 210 and the apparatus 10 of the present invention can utilize any number of inkjet devices depending upon the application or use of the apparatus 10. In one embodiment of the invention, each of the inkjet devices 222, 224 and 226 can move independently of each other while printing. This may be advantageous when printing more than one panel on a substrate.

In one embodiment, a chemical compound application assembly 500 to apply (or dispense) the surface active compound is attached to the front side of the inkjet printing module support 220. The chemical compound application assembly 500 comprises a chemical compound applicator 510 and a chemical compound supply line 520. The chemical compound could be in liquid form or in gas form. Chemical compound could be applied to the substrate 330 surface one time (one layer) or multiple times (multiple times). In one embodiment, the chemical compound applicator 510 has a width 570 that is wide enough to cover the whole width 370 of the substrate 330. In one embodiment, the chemical compound applicator 510 applies (or dispenses) vapor containing the surface active compound essentially across the entire width 570 of the chemical compound applicator 510. During the vapor application process, the substrate 330 move along the Y axis to allow the entire substrate 330 surface to be exposed to (or deposited with) the vapor that contains the surface active compound. In one embodiment, substrate 330 moves at a speed between about 0 m/s to about 5 m/s and preferably at a speed between about 0.3 m/s to about 0.7 m/s. In another embodiment, the width 570B of the chemical compound applicator 510 is less than the whole width 370 of the substrate 330. For example, the width 570B could be ½ the size of the substrate width 370. During the vapor application process, the substrate 330 move along the Y axis to allow ½ of the substrate be exposed to (or deposited with) the surface active compound vapor. Afterwards, the substrate can move along X axis by ½ the width 570 of the substrate to allow the other ½ of the substrate be exposed to (or deposited with) the surface active compound vapor by moving the substrate 330 along the Y axis.

In another embodiment, the chemical compound applicator 510 can be placed along the Y direction as shown in FIG. 6B. It can be attached to a raised bar (not shown) placed along Y direction of the top portion 322 of the stage positioning system 320 or be attached to the inkjet prining module support 220 (as shown in FIG. 6B). Its width 570′ should be wider than the length 370′ of the substrate 330. During the vapor application process, the chemical compound applicator 510 move along the X-axis to allow the entire substrate 330 surface to be exposed to (or deposited with) the vapor the contains the surface active compound. In another embodiment, the width 570B′ of the chemical compound applicator 510′ is smaller than the length 370′ of the substrate.

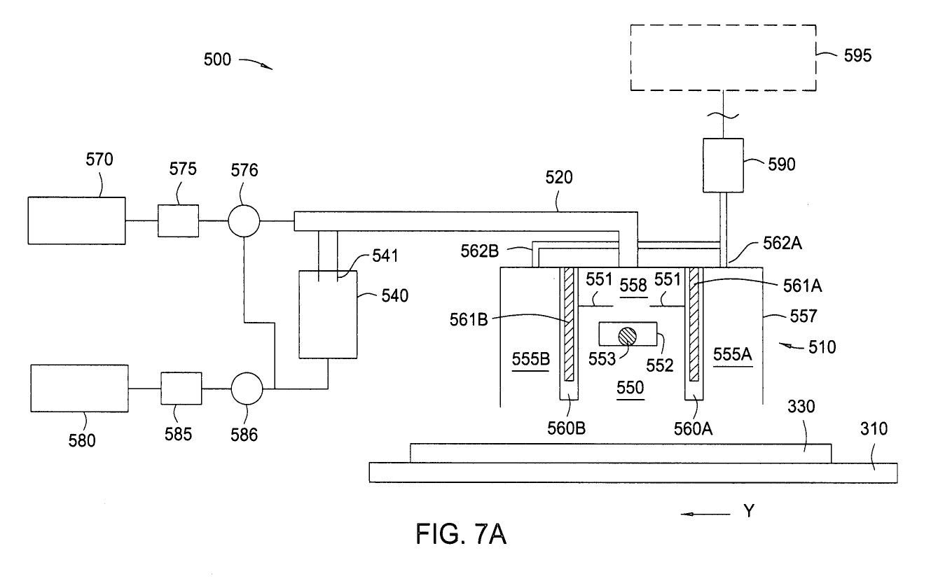

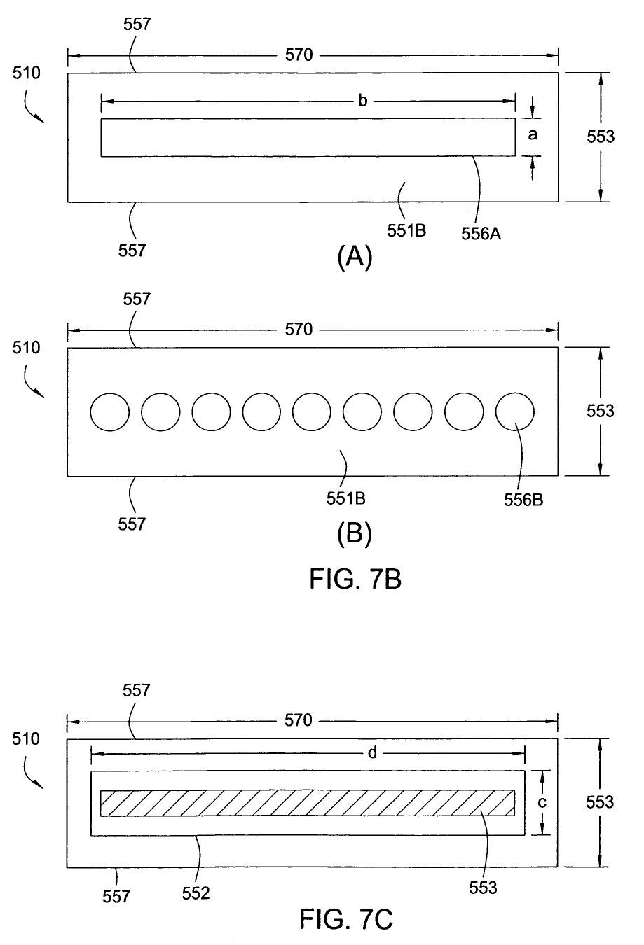

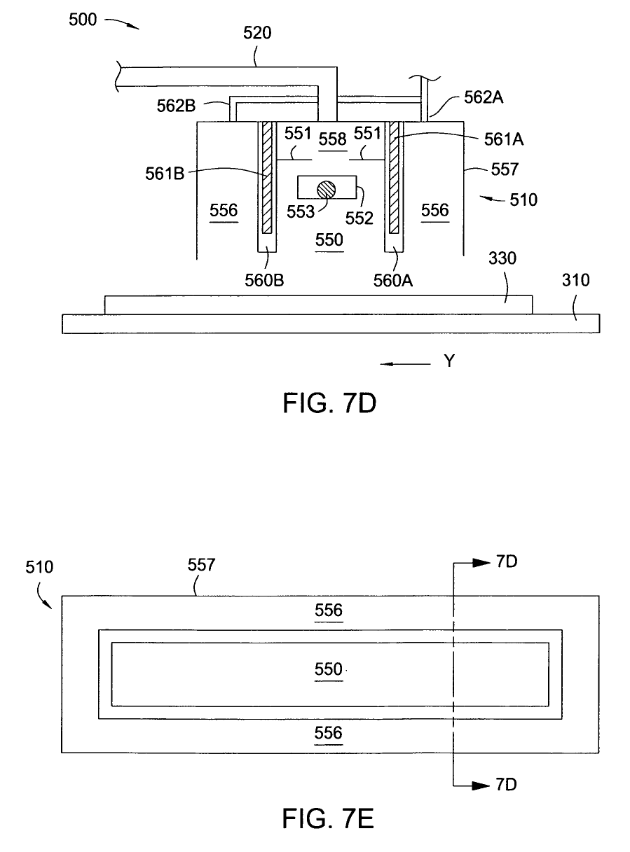

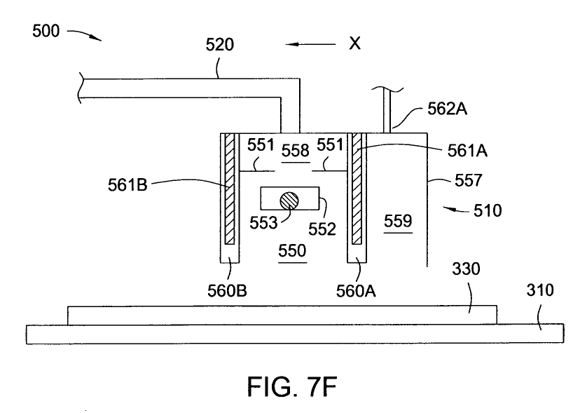

FIG. 7A is a schematic side view of the chemical compound application assembly 500 of FIG. 6 with substrate 330 and the stage 310 below it. The substrate 330 sits on the stage 310. In one embodiment, the stage 310 can move in the Y direction. The chemical compound application assembly 500 comprises the chemical compound applicator 510 and the chemical compound supply line 520. The chemical compound supply line 520 is connected to a vaporizer 540, which is communication with a liquid source 580 of surface active compound via a liquid flow meter 585 and a valve 586, and a carrier gas source 570 via a mass flow controller (MFC) 575 and a three way valve 576. In one embodiment, the carrier gas and the vapor of surface active compound is mixed before entering a vapor chamber 550. In one embodiment, the gas mixture of the carrier gas and the vapor of surface active compound has a flow rate between about 0.1 g/min to about 500 g/min and preferably at a flow rate between 1 g/min to about 100 g/min.

Heating elements (or devices) are disposed around the perimeter of the vaporizer 540 provide thermal energy to heat the vaporizer 540 to a temperature sufficient to vaporize the surface active compound. Optionally, an ultrasonic homogenizer could be disposed in the vaporizer to facilitate vaporization of the surface active compound. The vaporized surface active compound is removed from the vaporizer 540 at vaporizer outlet 541 and flowed through a line 520 that connects the vaporizer 540 and a chemical compound applicator 510. Vaporizer 540 of the chemical compound application assembly 500 may be a commercially available vaporizer, such as a VoDM-A vaporizer available from MKS Instruments of Wilmington, Mass.

The liquid chemical (surface active compound) passes through the vaporizer 540, such as a multi-channel vaporizer manufactured by Porter Instrument Company of Hatfield, Pa. The vapor of the chemical is then mixed with a carrier gas, such as nitrogen, and flow through a heated tubing 520 to the chemical compound applicator 510. The temperature of the vaporizer 540, chemical compound supply line 520 and chemical compound applicator 510 need to be maintained to be above the boiling point of the surface active compound. For example, the boiling point of S107B polymer is 98° C. In one embodiment, the set temperature of the vaporizer 540 is 160° C. to ensure rapid vaporization of the liquid S107B polymer. The chemical compound supply line 520 and the chemical compound applicator 510 are set at 110° C. The boiling point of silicon oil is about 250° C. The set temperatures for the vaporizer 540, chemical compound supply line 520, and chemical compound applicator 510 for silicon oil can be adjusted according.

In one embodiment, the chemical compound applicator 510 comprises a vapor chamber 550 and two exhaust chambers 555A, 555B. The vapor chamber 550 is separated from the two exhaust chambers 555A, 555B through dividers 560A, 560B. The vapor chamber 550 has a positive pressure and supplies the vapor containing the surface active compound, while the exhaust chambers 555A, 555B have negative pressure and pumps gas out of the chamber. In one embodiment, each divider 560A or 560B has an embedded heater 561A or 561B to maintain the surface active compound to be at vapor form. The vapor chamber 550 includes two outer walls 557. In one embodiment, the lowest points of the outer walls 557 is higher than the lowest points of dividers 560A, 560B for all residual vapor containing the surface active compounds to be pumped to an system exhaust 595. However, the lowest point of the dividers 560A, 560B can also be higher than or at essentially the same level as the lowest point of the outer walls 557. The distance of the lowest point of the chemical compound applicator 510 should be less than 1 mm from the glass substrate 330. The minimal distance between the dividers 560A, 560B and the closest outer walls 557 is 1 mm.

To ensure the vapor of the surface active compound is distributed evenly across the entire chemical compound applicator 510, in one embodiment the vapor chamber 550 further comprises baffle plate 551, and a diverter 552. The baffle plate 551 allows the vapor to distribute across the chemical compound applicator 510 in the upper region 558 of the vapor chamber before going downstream of the vapor chamber 550. When it moves towards downstream of the vapor chamber 550, the vapor encounters the diverter 552, which further enhances the redistribution of vapor across the width 570 (See FIGS. 7B, and 7C) of the chemical compound applicator 510. In one embodiment, the diverter 552 is heated by a heating element (or device) 553 to maintain the vapor temperature to be at above the boiling point of the surface active compound. In one embodiment, the heating element (or device) 553 is maintained at 140° C. to maintain the outer walls 557 to be at 110° C.

FIG. 7B shows schematic top views of two embodiments of the baffle plate 551 of FIG. 7A. In the (A) embodiment, the baffle plate 551A is a plate with a long slit 556A. In one embodiment, the slit 556A is a rectangular. The slit 556A allows the vapor to move towards downstream of vapor chamber 550. The width “a” of the slit 556A should not be too large to allow the vapor to distribute across the vapor applicator 550. The width “a” of the slit 556A should not be too small to prevent the sufficient vapor flow from moving towards down stream of the vapor chamber 550. In the (B) embodiment, the baffle plate 551B comprises more than one opening 556B. The opening 556B could be any shape. In one embodiment, the opening 556B is circular. The diameter of the circular opening 556B is smaller than the depth 553 of the chemical compound applicator 510. The at least one opening 556B of across the chemical compound applicator 510 does not have to be at the same size or shape.

FIG. 7C shows a schematic top view of one embodiment of the diverter 552. The diverter in FIG. 7C is shaped as a rectangle viewing from top. The width “C” of the diverter is less than the depth “553” of the chemical compound applicator 510. However, there should be sufficient space between the diverter 552 and the outer-walls 557 of the chemical compound applicator 510 to allow vapor to move towards downstream of the vapor chamber 550.

Referring back to FIG. 7A, there are two exhaust chambers 555A, 555B, on both sides of the vapor chamber 550. The exhaust chambers 555A, 555B are connected to a cold trap 590 to recover the un-used surface active compound through gas lines 562A, 562B. In one embodiment, the gas lines 562A, 562B are heated to prevent the surface active compound from densifying into liquid along the lines 562A, 562B. The cold trap 590 is connected to the exhaust system 595, which has a pump to pump out exhaust gas. In another embodiment, there is only one exhaust chamber 556 surrounding the vapor chamber 550. The cross section of the chamber 556 is shown in FIG. 7D and the top view of the chamber 556 is shown in FIG. 7E. In yet another embodiment, there is only one exhaust chamber 559 (as shown in FIG. 7F). When the chemical compound applicator 510 move along X direction across the surface of substrate 330, the exhaust chamber 556 collects the exhaust gas out of the behind the vapor chamber 550 and pumps out the exhaust gas.

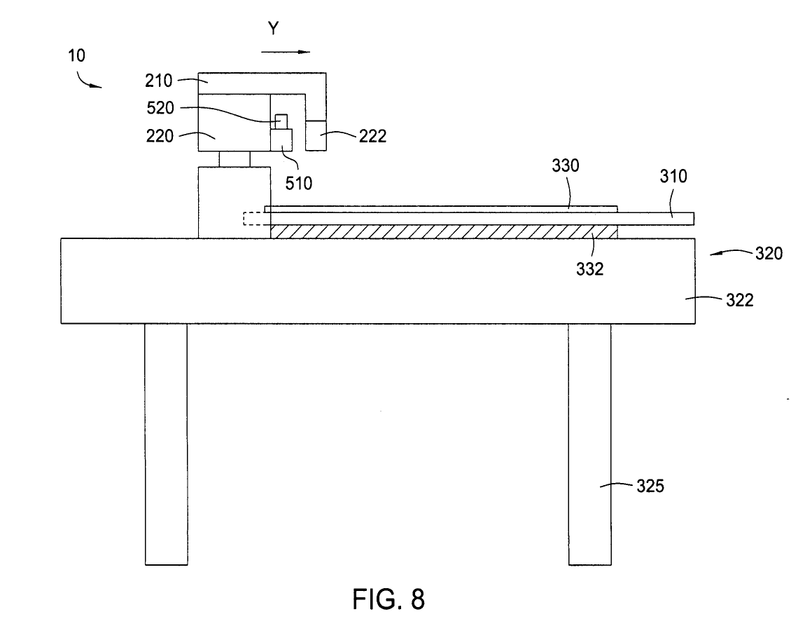

FIG. 8 shows a schematic side view of the inkjetting apparatus 10 of FIG. 6. The apparatus comprises a stage positioning system 320, which includes a stage 310. The stage 310 moves in the Y direction through a stage moving device 332 and supports substrate 330. The stage positioning system 320 also include a top portion 322, which is supported by legs 325. The apparatus 10 also comprises inkjet heads 222, 224, 226 (224 and 226 are behind 222), which are supported by the inkjet printing module support 220. The vapor applicator 210 is coupled to the inkjet printing module support 220 and is placed behind the inkjet heads 222, 224, 226. The inkjet heads 222, 224, 226 move in the X direction without hitting the vapor applicator 210.

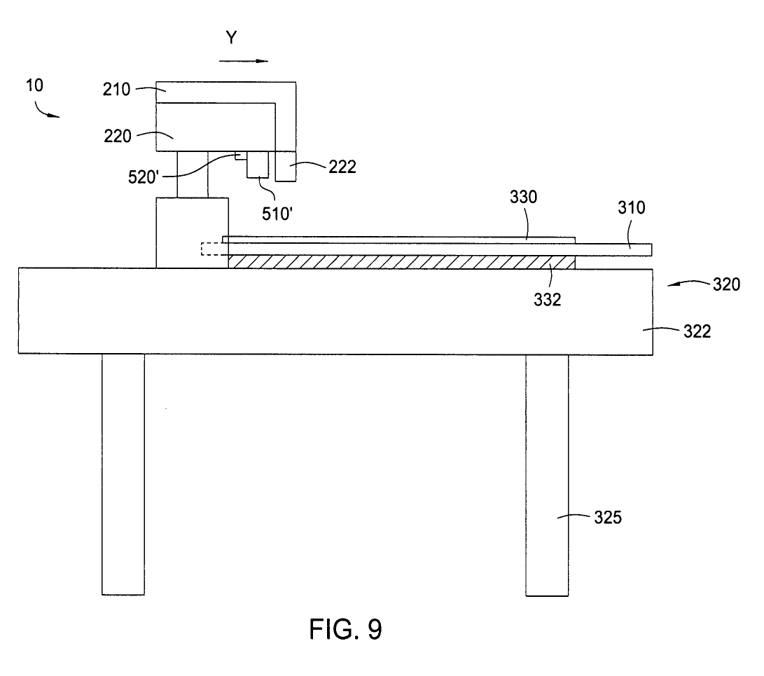

FIG. 9 shows another embodiment of the invention. The chemical compound applicator 510′ is placed below the inkjet printing module support 220. The chemical compound supply line 520′ is fed to the side of the chemical compound applicator 510′ near the top.

Before the substrate 330 is exposed to the inkjet, the vapor with surface active compound is applied across the substrate 330 by moving the substrate 330 in Y-direction. Since the width 570 (see FIGS. 7B and 7C) of the chemical compound applicator 510 is wider than the width 370 of the substrate 330, the entire substrate surface can be applied with the vapor of surface active compound.

In one embodiment, a thermal blanket (not shown) is placed around the chemical compound applicator 510 to prevent heat loss from the chemical compound applicator 510 from affecting the inkjet printing devices 222, 224, 226 and the substrate 330. The thermal blanket minimizes heat transfer effect to the surrounding environment.

While FIGS. 6A to 9 show examples of an integrated apparatus that may be used to expose the glass substrate and black matrix to a surface active compound before the inkjet deposition, other equipment may be used. The apparatus used to expose the glass substrate and black matrix to the surface active compound may include one or more stand-alone pieces of equipment or one or more pieces of equipment that are integrated with other pieces of equipment that are used to process the substrate. For example, the equipment may be integrated with a system used to pattern the black matrix such that the glass substrate and the black matrix may be exposed to the surface active compound immediately after the last step of the formation of the black matrix, such as a rinsing step. The treatment may also be combined with other surface treatment steps, such as baking, before color filter deposition in the inkjet system.

It is believed that embodiments of the invention may be used to treat many or all of the commercially available black matrix materials, such as black matrix resins, which generally include one or more pigments, such as carbon black or an organic pigment, dispersed in a resin, such as an acrylic or polyimide resin, and chromium oxide-based black matrix materials that include a photoresist. It is also believed that embodiments of the invention may be used with many or all of the commercially available inks used for color filters. The inks may include components such as color pigments and dyes, solvents, additives, acrylic monomers, and acrylic and/or methacrylic oligomers.

Sub-pixel wells containing ink with a substantially uniform upper surface profile have been obtained using embodiments of the invention. By coating the surface of both the glass substrate at the bottom of a sub-pixel well and the black matrix surrounding the sub-pixel well with a layer deposited from the surface active compounds described herein, the surface energies of the black matrix and the glass substrate are made identical or very similar, and the spreading of the ink within the sub-pixel well is substantially unaffected by the composition of the black matrix prior to the treatment of the black matrix with the surface active compound. Further evidence that embodiments of the invention provide the coated black matrix and coated glass substrate with similar surface energies is provided by data collected from tests in which 30 picoliter drops of an ink were deposited on a glass substrate and a black matrix using a Spectra SE128 inkjet printhead. Immediately after the drops were deposited, the diameter of the deposited drops on the black matrix and glass substrate were measured using a Keyence VH digital microscope that has the capability to measure the radius of the deposited drop. It was found that a drop of one type of ink deposited on either a black matrix material or glass substrate resulted in the formation of drops with different diameters on the different materials, while a drop of the same type of ink deposited on either a black matrix material or glass substrate treated according to embodiments of the invention results in the formation of drops having substantially similar diameters. The drop radii of a drop of ink on the treated glass substrate and a drop of ink on the treated black matrix were smaller than the drop radii of a drop of ink on the untreated glass substrate and the untreated black matrix respectively. Thus, the ink-philicity of the glass substrate and the ink-philicity of the black matrix were decreased by the treatment. Preferably, the drop radius of an ink drop on a treated glass substrate is about 6% to about 30% less than the drop radius of an ink drop on an untreated glass substrate, and the drop radius of an ink drop on a treated black matrix is about 6% to about 30% less than the drop radius of an ink drop on an untreated black matrix.

While it was found that embodiments of the invention provide an apparatus and a method of enhancing the formation of ink drops of some inks with a ratio of the drop radius of the ink on the black matrix to the drop radius of the ink on the glass substrate of about 1:1, it was also found that for other inks, glass substrates, and black matrices having different surface properties, the ratio of the drop radius of the ink on the black matrix to the drop radius of the ink on the glass substrate may be decreased from about 1:1 to about 0.8:1. For example, the ratio may be changed from about 1:1 to about 0.8:1 by increasing the ink-phobicity of the black matrix relative to the glass substrate.

Other embodiments of the invention provide a method of making a black matrix surface more ink-philic while making a glass substrate surface more ink-phobic by treating the black matrix and glass substrate with a surface active compound that has a surface energy that is higher than the surface energy of the black matrix and lower than the surface energy of the glass substrate. A ratio of the drop radius of an ink on a black matrix to the drop radius of the ink on a glass substrate changed from 0.56:1 to 0.8:1 when a glass substrate and a highly ink-phobic black matrix were treated with a surface active compound that had a surface energy higher than the surface energy of the black matrix and lower than the surface energy of the glass substrate.

Thus, embodiments of the invention provide methods of changing the ratio of the drop radius of an ink on a black matrix to the drop radius of the ink on a glass substrate from greater than about 1:1 or less than about 0.8:1 to between about 0.8:1 and about 1:1.

Thus, embodiments of the invention provide an apparatus and a method of treating a glass substrate and a black matrix that enhances the quality of color filters manufactured by inkjet printing systems. By depositing a thin layer on the glass substrate and black matrix from the surface active compound, the black matrix may also be protected from undesirable reactions with the ink and is not physically damaged by the treatment process itself.

While the foregoing is directed to embodiments of the present invention, other and further embodiments of the invention may be devised without departing from the basic scope thereof, and the scope thereof is determined by the claims that follow.

What is claimed is:

1. An inkjet printing system for a substrate of flat panel display, comprising:
a chemical compound application assembly that applies chemical compound(s) on the substrate of flat panel display;
a stage that supports the substrate of flat panel display and a stage positioning system that moves the stage; and
an inkjet printing module that dispenses inkjet on the substrate of flat panel display.

2. The inkjet printing system of claim 1, wherein the chemical compound application assembly can move across the surface of the substrate of flat panel display.

3. The inkjet printing system of claim 1, wherein the chemical compound application assembly comprises a chemical compound applicator whose width substantially spans the width of the substrate of flat panel display.

4. The inkjet printing system of claim 1, wherein the chemical compound application assembly comprises a chemical compound applicator whose width spans less than the width of the substrate of flat panel display.

5. The inkjet printing system of claim 1, wherein the chemical compound application assembly comprises a vaporizer that vaporize a liquid chemical compound, wherein the vaporized chemical compound is mixed with a carrier gas downstream from the vaporizer to be carried the chemical applicator by a vapor supply line and the chemical applicator and the vapor supply line both have heating devices to keep the vaporized chemical compound in vapor form.

6. A processing system for a substrate of flat panel display, comprising:
a chemical compound application assembly that applies chemical compound(s) on the substrate of flat panel display wherein the chemical compound application assembly has a chemical compound applicator whose width substantially spans the width of the substrate of flat panel display; and
a stage that supports the substrate of flat panel display and a stage positioning system that moves the stage.

7. The processing system of claim 6, wherein the chemical compound application assembly is stationary.

8. The processing system of claim 6, wherein the chemical application assembly can move across the surface of the substrate of flat panel display.

9. The processing system of claim 6, further comprises an inkjet printing module that dispenses inkjet on the substrate of flat panel display wherein the inkjet printing module has at least three inkjet heads whose axes are placed substantially along one line, and the axis of the chemical compound applicator is parallel to the line.

10. The processing system of claim 6, further comprises an inkjet printing module that dispenses inkjet on the substrate of flat panel display wherein the inkjet printing module has at least three inkjet heads whose axes are placed substantially along one line, and the axis of the chemical compound applicator is perpendicular to the line.

11. A processing system for a substrate of flat panel display, comprising:
a chemical compound application assembly that applies chemical compound(s) on the substrate of flat panel display through a chemical compound applicator of the chemical compound application assembly.

12. The processing system of claim 11, wherein the chemical compound applicator comprises a chamber that applies chemical compound(s) on the substrate of flat panel display and at least one exhaust chamber which pumps the exhaust from the chemical compound applicator away from the surface of the substrate of flat panel display.

13. The processing system of claim 11, wherein the width of the chemical compound applicator substantially spans the width of the substrate of flat panel display.

14. The processing system of claim 13, wherein the chemical compound application assembly further comprises a vaporizer that vaporize liquid chemical compound, wherein the vaporized chemical compound is mixed with a carrier gas and be supplied to the chemical compound applicator a chemical compound supply line.

15. The processing system of claim 14, wherein the chemical compound supply line and the chemical compound applicator both have heating devices to keep the chemical compound in vapor form.

16. A method of processing a substrate of flat panel display, comprising:
depositing a layer comprising a chemical compound on the surface of a substrate of flat panel display by a chemical compound application assembly, whose width spans substantially the width of the substrate of flat panel display, of a processing system; and then
inkjetting at least three colors on the substrate of flat panel display by an inkjet printing module of the processing system.

17. The method of claim 16, wherein the chemical compound, which is in liquid form at room temperature, is vaporized by a vaporizer of the chemical compound application assembly and is supplied to a heated chemical compound applicator of the chemical compound application assembly by a heated supply line of the chemical compound application assembly before the chemical compound is deposited on the substrate of flat panel display.

18. The method of claim 16, wherein the heated chemical compound applicator and the heated supply line maintain the chemical compound in vapor form.

19. The method of claim 16, wherein the chemical compound is mixed with a carrier gas after it is vaporized by the vaporizer.

20. The method of claim 17, wherein depositing the layer comprising the chemical compound is accomplished by moving the substrate of flat panel display under the chemical compound applicator.

21. The method of claim 17, wherein depositing the layer comprising the chemical compound is accomplished by moving the chemical compound applicator across the surface of the substrate of flat panel display.

22. The method of claim 17, wherein depositing the layer comprising the chemical compound is accomplished by moving the substrate of flat panel display under the chemical compound applicator multiple times.

23. The method of claim 17, wherein depositing the layer comprising the chemical compound is accomplished by moving the chemical compound applicator across the surface of the substrate of flat panel display multiple times.

24. The method of claim 16, wherein the substrate of flat panel display has a black matrix on the surface prior to depositing the layer of chemical compound.

25. The method of claim 24, wherein the chemical compound is a surface active compound to increase or decrease the ink-phobicity or ink-philicity of at least one member selected from the group consisting of the black matrix and an outer surface of the substrate of flat panel display that is not covered by the black matrix prior to delivery of an ink within sub-pixel wells of the black matrix.

26. The method of claim 25, wherein the surface is either a fluoroalkyl polyoxyethylene polymer or a polydimethylsiloxane.
